(19) United States
(12) Patent Application Publication
(10) Pub. No.: US 2011/0248472 A1
(43) Pub. Date: Oct. 13, 2011

(54) Motorcycle assembly

(76) Inventor: Tom Chu, Frisco, TX (US)

(21) Appl. No.: 12/758,572

(22) Filed: Apr. 12, 2010

(51) Int. Cl. B62J 23/00

(52) U.S. Cl. 280/304.3

(57) ABSTRACT

A device to protect the frame of the motorcycle may include An engine to drive the motorcycle, a frame to support the motorcycle, a left bracket to mount on a left side of the motorcycle between the frame and engine, and a right bracket to mount on the right side of the motorcycle between the frame and engine. The left bracket may be connected to a first frame slider, and the right bracket may be connected to a second frame slider. The first frame slider may extend beyond the frame of the motorcycle, and the second frame slider may extend beyond the frame of the motorcycle. The left bracket may include a first portion and the left bracket may include a second portion connected to the first portion. The left bracket may include a third portion connected to the second portion and the third portion may include a first side wall, a second side wall and a top wall to connect to the frame.

### FIELD OF THE INVENTION

The present invention relates to motorcycle protection and more particularly to a frame slider and corresponding offset bracket in order to prevent excessive damage to the motorcycle after a fall.

### BACKGROUND

Motorcycles of today are generally two wheeled vehicles which generally depend on a kickstand in order to remain in the upright position while at rest and depend on the balance of the user to maintain the motorcycle in an upright position while being used. The motorcycle of today may be a very expensive vehicle and may include stylish and performance bodies in order to enhance the experience of using the motorcycle. A disadvantage is that these bodies may be formed from light weight plastics in order to achieve lighter weights. These bodies may be subject to scratching and being deformed as a result of either an accident while being used or in inadvertently tipping over while parked. It would be desirable to eliminate or minimize this damage.

### SUMMARY

A device to protect the frame of the motorcycle may include An engine to drive the motorcycle, a frame to support the motorcycle, a left bracket to mount on a left side of the motorcycle between the frame and engine, and a right bracket to mount on the right side of the motorcycle between the frame and engine.

The left bracket may be connected to a first frame slider, and the right bracket may be connected to a second frame slider.

The first frame slider may extend beyond the frame of the motorcycle, and the second frame slider may extend beyond the frame of the motorcycle.

The left bracket may include a first portion and the left bracket may include a second portion connected to the first portion.

The left bracket may include a third portion connected to the second portion and the third portion may include a first side wall, a second side wall and a top wall to connect to the frame.

The first portion may connect to the engine, and the right bracket may include a fourth portion.

The right bracket may include a fifth portion connected to the fourth portion, and the right bracket may include a sixth portion connected to the fifth portion.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a left bracket of the present invention;

FIG. 2 illustrates a perspective view of a right bracket of the present invention;

FIG. 3 illustrates a right side view of the left bracket of the present invention;

FIG. 4 illustrates a right side view of the right bracket of the present invention;

FIG. 5 illustrates a top view of the left bracket of the present invention;

FIG. 6 illustrates a top view of the right bracket of the present invention;

FIG. 7 illustrates a front view of the left bracket of the present invention;

FIG. 8 illustrates a front view of the right bracket of the present invention;

FIG. 9 illustrates a left side view of the left bracket of the present invention;

FIG. 10 illustrates a left side view of the right bracket of the present invention;

FIG. 11 illustrates a back side view of the left bracket of the present invention;

FIG. 12 illustrates a back side view of the right bracket of the present invention;

FIG. 13 illustrates a bottom view of the left bracket of the present invention;

FIG. 14 illustrates a bottom view of the right bracket of the present invention;

FIG. 15 illustrates a front view of the right and left brackets mounted on the motorcycle;

FIG. 16 illustrates a top view of the right and left brackets mounted on the motorcycle.

### DETAILED DESCRIPTION

The present invention provides for a frame slider to extend from the side of the motorcycle in order to receive the impact whenever the motorcycle is inadvertently or accidentally tipped over on its side. Furthermore the present invention provides for a bracket which may be securely mounted on the motorcycle and which may utilize the frame and engine of the motorcycle. The frame slider is then mounted on the bracket and may extend substantially perpendicular to the side of the motorcycle in order to receive the impact from the motorcycle tipping on its side.

The present invention may employ a bracket on each side of the motorcycle in order to serve as a mount for the frame slider.

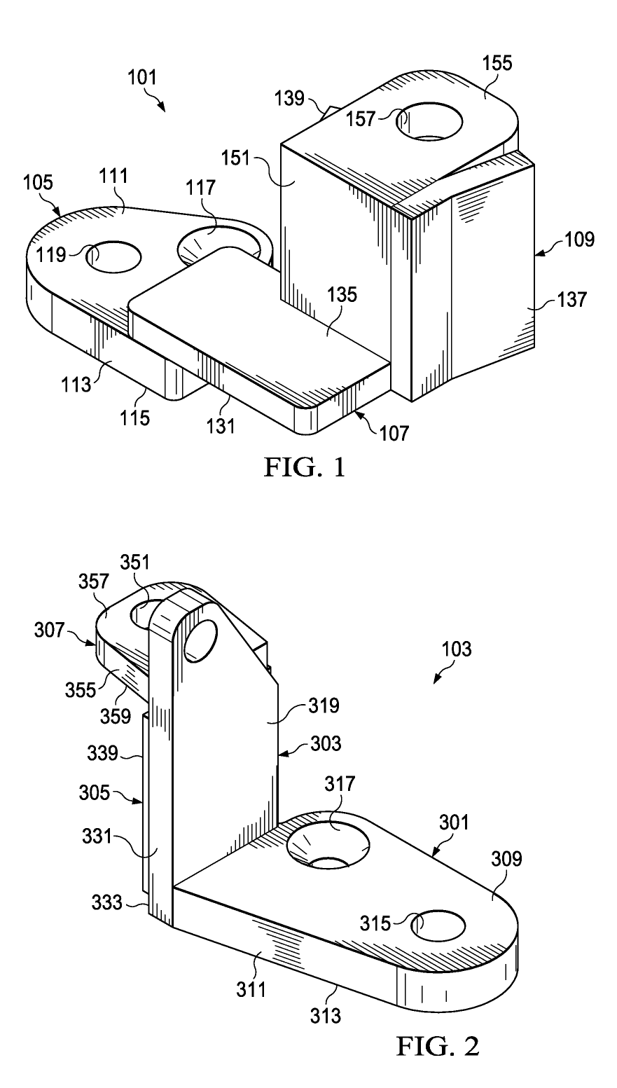

FIG. 1 illustrates a bracket which may be a left bracket 101 which may be used to secure a frame slider to a motorcycle, and the left bracket 101 may include a first left bracket portion 105, a second left bracket portion 107 which may be connected to the first left bracket portion 105 and a third bracket portion 109 which may be connected to the second portion 107. The left bracket 101 and the right bracket 103 may be substantially solid or hollow and may be formed from metal, high strength plastic or other appropriate material. The first portion 105 may be substantially heart-shaped and may include a first top surface 111 which may extend to the first side surface 113 which may extend to the first bottom surface 115 and the first portion 105 may include a first aperture 117 which may include a truncated cone shaped side surface (counter sunk) in order to accept a fastener such as a bolt, screw or other appropriate fasteners and a second aperture 119 in order to cooperate with the frame slider. The top surface 111 may be connected such as by welding to a bottom surface 131 of the second portion 107 which may extend across the portion of the top surface 111. The second portion 107 may be substantially rectangular or other appropriate shape, and the bottom surface 131 may be connected to a side surface 133 which may extend continuously around the periphery of the second portion 107 and which may be connected to the top surface 135 of the second portion 107. The top surface 135 may be connected to the third portion 109.

The third portion 109 may include a front wall 151 which may be connected to the top surface 135 of the second portion 107 and the front wall 151 may be connected to a first side wall 137 which may extend from the bottom surface 131 of the second portion 107 and may extend to the top surface 155 of the third portion 109. The first side wall 137 may be concavely shape and the second side wall 139 may be concavely shaped. The second side wall 139 may be connected to the top surface 135 of the second portion 107 and may extend to the top surface 155. The first and second side wall 137, 139 may be connected to the front wall 151 which may be connected to a top wall 155 which may include a central aperture 157 and which may include rounded corners.

FIG. 2 illustrates a perspective view of the right bracket 103 of the present invention and may include a fourth right bracket portion 301, a fifth right bracket portion 303, a sixth right bracket portion 305, and seventh right bracket portion 307.

The fourth portion 301 may include a top surface 309 which may include a first aperture 315 may include a second aperture 317 (which may be counter sunk), and the top surface 309 may be connected to a peripheral side surface 311 which may extend continuously around the top surface 309. The side surface 311 may be connected to the bottom surface 313. One end of the side surface 311 may be connected to the top surface 319 of the fifth portion 303, and the top surface 319 may be connected to a side surface 331 which may extend around the periphery of the fifth portion 303 and the side surface 331 may be connected to the back surface 333 which may be connected to the back surface 335 of the sixth portion 305. The side surface 337 may extend around the periphery of the back surface 335 and may be connected to the front surface 339. Additionally, the back surface 333 may be connected to a side surface 355 of the seventh portion 307 which may be connected to the top surface 357 and the bottom surface 359. The top surface 357 may include an aperture 351.

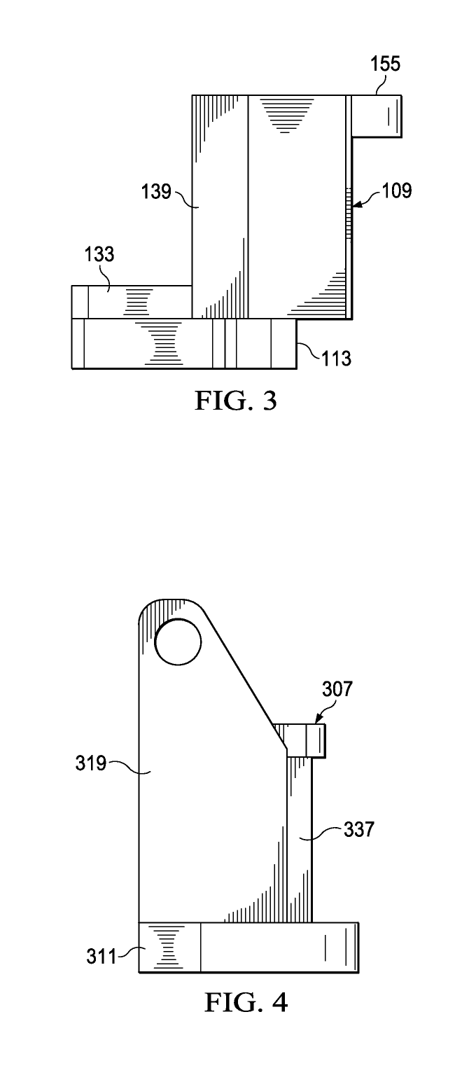

FIG. 3 illustrates a right side view of the left bracket of the present invention and illustrates the side surface 113 of the first portion 105, the side surface 133 of the second portion 107, and the first side surface 137 of the third portion 109.

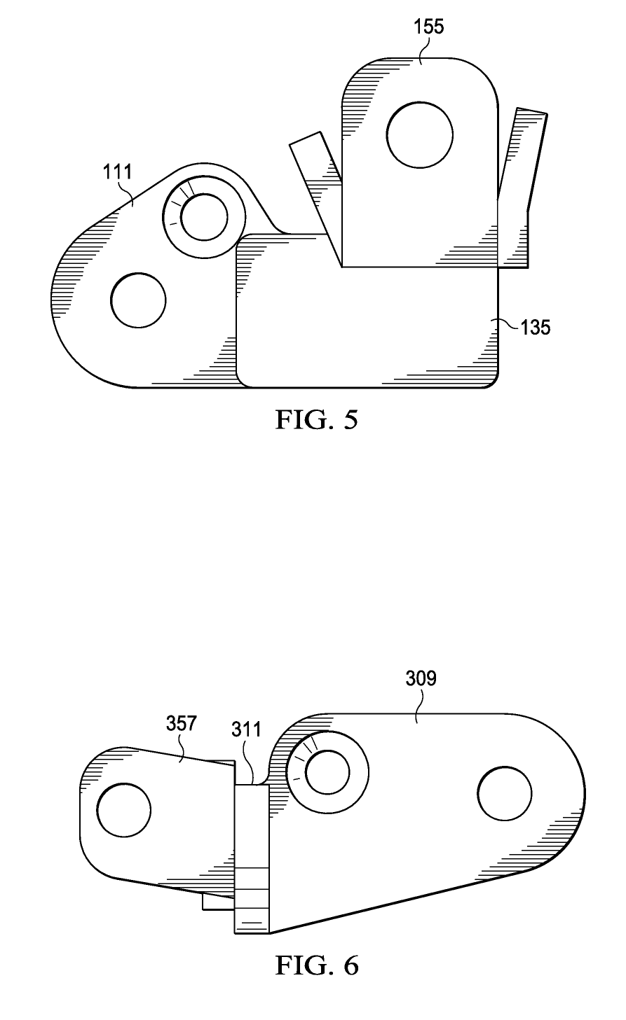

FIG. 4 illustrates a right side view of the right bracket of the present invention and illustrates the side surface of the fourth portion 301, the top surface 319 of the fifth portion 303, the top surface 337 of the sixth portion 305 and the side surface 355 of the seventh portion 307.

FIG. 5 illustrates a top view of the left bracket of the present invention and illustrates the top surface 111 of the first portion 105, the top surface 135 of the second portion 107 and illustrates the top wall 155 of the third portion 109.

FIG. 6 illustrates a top view of the right bracket of the present invention and illustrates the top surface 309 of the fourth portion 301, the side surface 331 of the fifth portion 303, and the top surface 357 of the seventh portion 307.

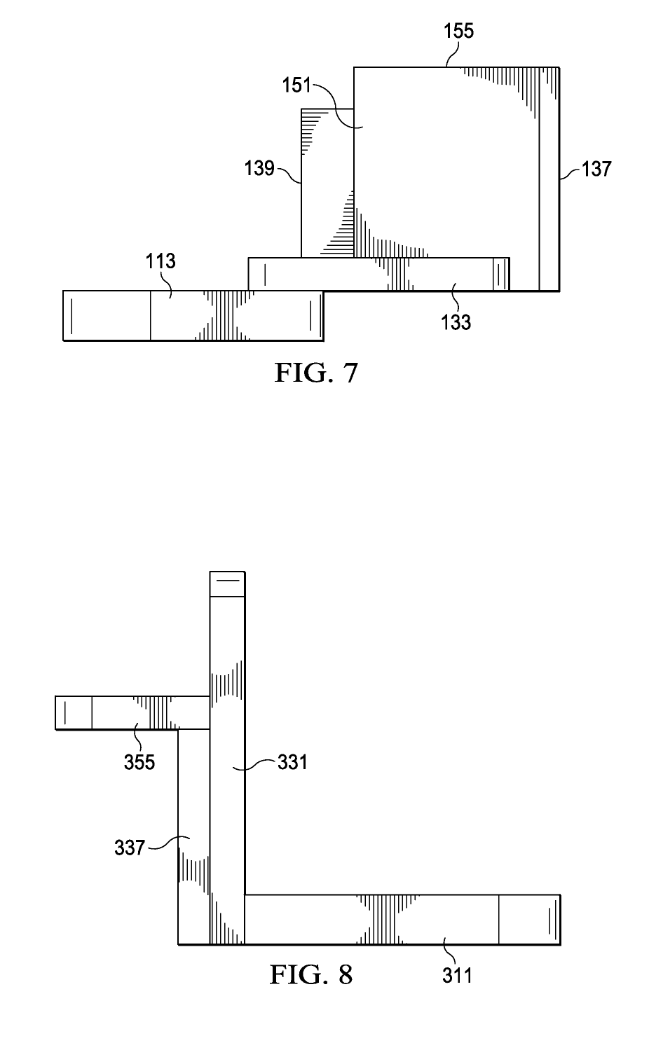

FIG. 7 illustrates a front view of the left bracket of the present invention and illustrates the side surface 113 of the first portion 105, the side surface 113 of the second portion 107 and illustrates the front wall 151. FIG. 7 additionally illustrates the first side wall 137, the second side wall 139 and the top wall 155.

FIG. 8 illustrates a front view of the right bracket of the present invention and illustrates the side surface 311 of the fourth portion 301, the side surface 331 of the fifth portion 303, the side surface 337 of the sixth portion 305 and the side surface 355 of the seventh portion 307.

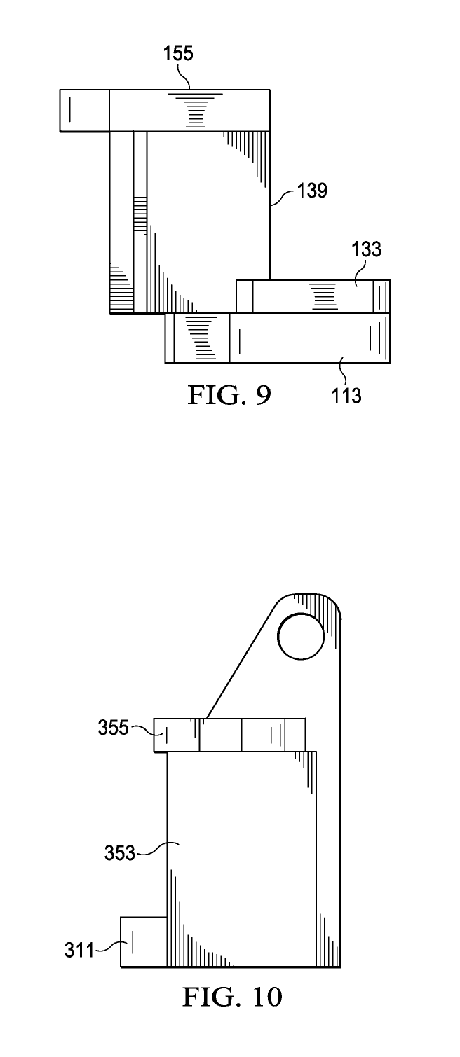

FIG. 9 illustrates a left side view of the left bracket of the present invention and illustrates the side surface 113 of the first portion 105, the side surface 133 of the second portion 107, the top wall 155 of the third portion 109 and the second side wall 139 of the third portion 109.

FIG. 10 illustrates a left side view of the right bracket of the present invention and illustrates the side surface 311 of the fourth portion 301, the back surface 333 of the fifth portion 303, the back surface 335 of the sixth portion 305 and the side surface 355 of the seventh portion 307.

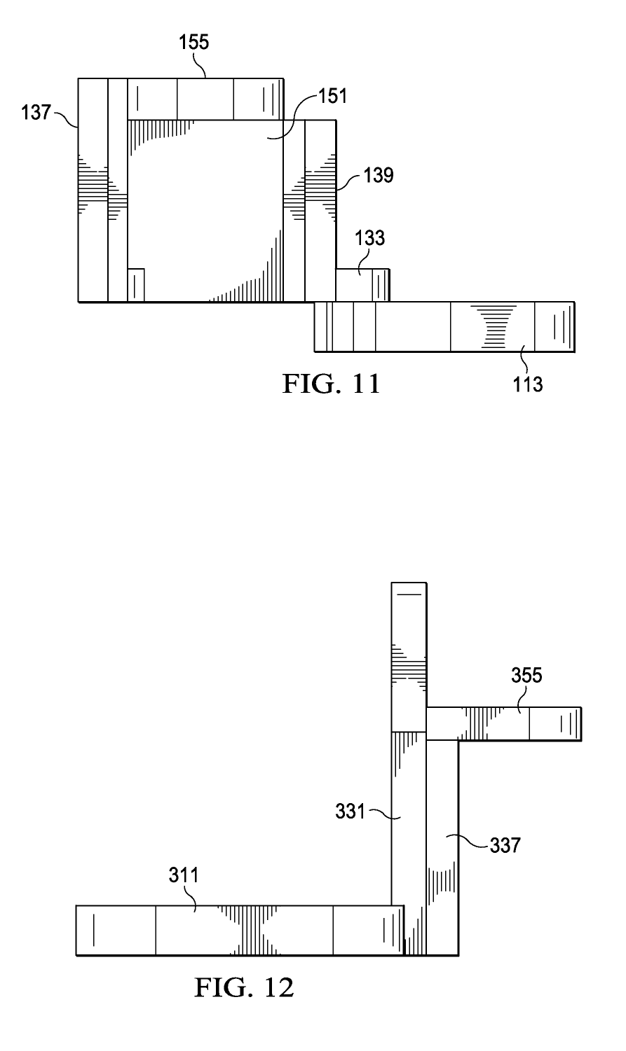

FIG. 11 illustrates a back view of the left bracket of the present invention and illustrates the side surface 113 of the first portion 105, the side surface 113 of the second portion 107 and illustrates the front wall 151. FIG. 7 additionally illustrates the first side wall 137, the second side wall 139 and the top wall 155.

FIG. 12 illustrates a back view of the right bracket of the present invention and illustrates the side surface 311 of the fourth portion 301, the side surface 331 of the fifth portion 303, the side surface 337 of the sixth portion 305 and the side surface 355 of the seventh portion 307.

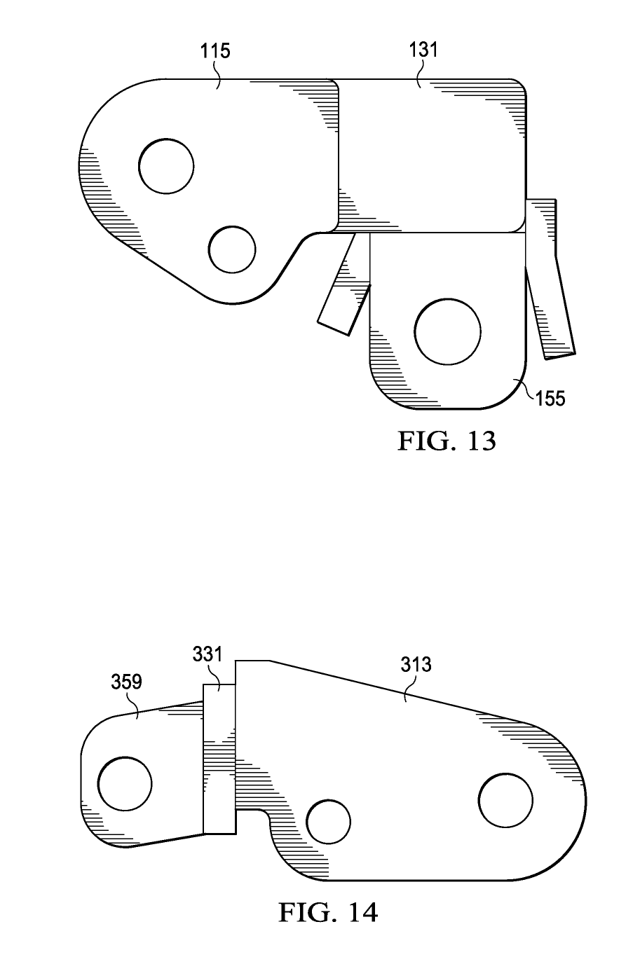

FIG. 13 illustrates a bottom view of the left bracket of the present invention and illustrates the bottom surface 115 of the first portion 105, the bottom surface 131 of the second portion 107 and illustrates the top wall 155 of the third portion 109.

FIG. 14 illustrates a bottom view of the right bracket of the present invention and illustrates the bottom surface 313 of the fourth portion 301, the side surface 331 of the fifth portion 303, and the bottom surface 359 of the seventh portion 307.

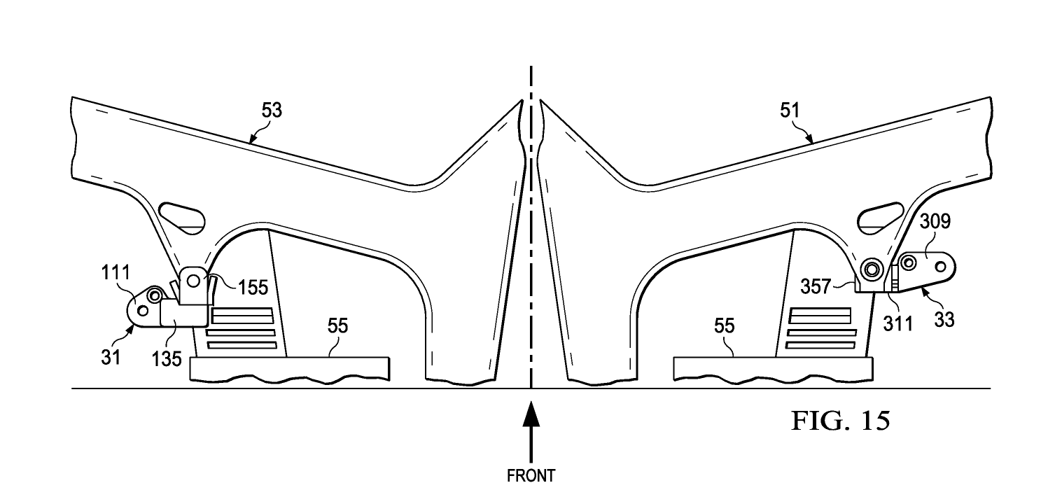

FIG. 15 illustrates a front view of the frame 53 and engine 55 which are connected to the left bracket 31 may be connected to a first frame slider 3 and the right bracket 332 be connected to a slider arm or second frame slider 3 (not shown). FIG. 15 illustrates the left bracket 31 of the present invention and illustrates the top surface 111 of the first portion 105, the top surface 135 of the second portion 107 and illustrates the top wall 155 of the third portion 109.

FIG. 15 illustrates the right bracket 33 of the present invention and illustrates the top surface 309 of the fourth portion 301, the side surface 331 of the fifth portion 303, and the top surface 357 of the seventh portion 307.

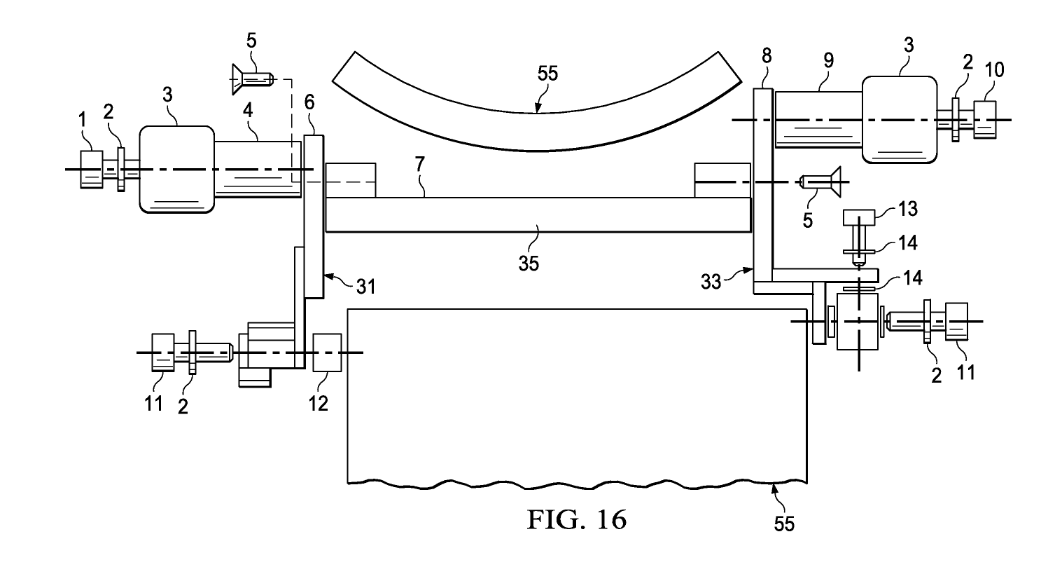

FIG. 16 illustrates the left bracket 31 connected to a center bracket 35 which may be connected to the right bracket 33 by a fastening device 5 such as a bolt. The left bracket 31 and the right bracket 33 may be positioned between the radiator of the motorcycle engine 55 and the block of the motorcycle engine 55. The slider arm or first frame slider 3 (which may be a cylinder or rectangle or other shape device) may be connected to a spacer 4 which may be a rod and connected to the left bracket 31 by a fastening device 1 which may be a bolt and spacer 2 which may be a washer. Additionally, the left bracket 31 may be connected to the cylinder of the engine 55 by a fastening device 11 such as a bolt and spacer 2 which may be a washer and a second spacer 12.

In a similar fashion, the opposing slider arm 3 may be connected to a spacer 9 which may be a rod and may be connected to the right bracket 33 by a fastening device 10 which may be a bolt and spacer 2 which may be a washer. Additionally, the right bracket 33 may be connected by a fastening device 11 which may be a bolt and a spacer 2 which may be a washer to the frame 51 and to the cylinder of the motorcycle engine 55.

While the left bracket 31 and the right bracket 33 may have taken on a specific shape in order to satisfy the requirements of a particular motorcycle, other embodiments of the left bracket and the right bracket are within the scope of the invention in order to mount a slider arm.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device to protect the frame of the motorcycle, comprising:
an engine to drive the motorcycle;
a frame to support the motorcycle;
a left bracket to mount on a left side of the motorcycle between the frame and engine;
a right bracket to mount on the right side of the motorcycle between the frame and engine;
wherein the left bracket is connected to a first frame slider, and the right bracket is connected to a second frame slider.

2) A device to protect the frame of the motorcycle as in claim 1, wherein the first frame slider extends beyond the frame of the motorcycle.

3) A device to protect the frame of the motorcycle as in claim 1, wherein the second frame slider extends beyond the frame of the motorcycle.

4) A device to protect the frame of the motorcycle as in claim 1, wherein the left bracket includes a first portion.

5) A device to protect the frame of the motorcycle as in claim 4, wherein the left bracket includes a second portion connected to the first portion.

6) A device to protect the frame of the motorcycle as in claim 5, wherein the left bracket includes a third portion connected to the second portion.

7) A device to protect the frame of the motorcycle as in claim 6, wherein the third portion includes a first side wall, a second side wall and a top wall to connect to the frame.

8) A device to protect the frame of the motorcycle as in claim 7, wherein the first portion connects to the engine.

9) A device to protect the frame of the motorcycle as in claim 1, wherein the right bracket includes a fourth portion.

10) A device to protect the frame of the motorcycle as in claim 9, wherein the right bracket includes a fifth portion connected to the fourth portion.

11) A device to protect the frame of the motorcycle as in claim 10, wherein the right bracket includes a sixth portion connected to the fifth portion.

12) A device to protect the frame of the motorcycle as in claim 11, wherein the right bracket includes a seventh portion connected to the sixth portion.

13) A device to protect the frame of the motorcycle as in claim 11, wherein the right bracket is connected to the left bracket by a central bracket.
